(19) United States
(12) Patent Application Publication
(10) Pub. No.: US 2012/0080634 A1
(43) Pub. Date: Apr. 5, 2012

(54) VALVE BORE SEALING METHOD AND APPARATUS

(75) Inventor: Stephen P. Fenton, Balmedie (GB)

(73) Assignee: VETCO GRAY INC., Houston, TX (US)

(21) Appl. No.: 12/895,386

(22) Filed: Sep. 30, 2010

(51) Int. Cl. F16K 13/02; F16J 15/02

(52) U.S. Cl. 251/328; 277/312

(57) ABSTRACT

A gate valve has a body, the body having a cavity and a flow passage intersecting the cavity. A seat ring is mounted to the body at the intersection of the flow passage and the cavity, the seat ring having an engaging face. A gate in the cavity has an engaging face that slidingly engages the face of the seat ring while being moved between open and closed positions. A seat sealing element is located in a cavity between seat rings and a counterbore formed in the flow passage and body of the valve. The sealing element blocks flow from the flow path to the interior of the valve. The sealing element also prevents debris from entering the counterbore-to-seat interface to improve sealing integrity. The sealing element has an axial spring property that enhances contact between the seat and gate and accounts for thermal expansion of the valve internals.

### FIELD OF THE INVENTION

This invention relates in general to gate valves, and in particular to a seat seal which prevents sand intrusion and provides sealing.

### BACKGROUND OF THE INVENTION

Gate valves are typically used in straight-line fluid flow applications with minimum flow restriction. When the valve is wide open, the gate is drawn from a valve into the opposite end of the valve cavity. Typically, the gate has body with a flow passage extending through the body to allow flow through the valve. The flow passage is typically the same size as the pipe in which the valve is installed.

A typical gate valve used in connection with oil and gas production has a flow passage that intersects a central cavity in the valve. Seat rings are placed in counterbores formed in the flow passage at the intersection of the flow passage with the cavity. An obstruction or gate is moved past the seats between open and closed positions to cause sealing.

The seats generally have seals which seal the seat to the counterbore of the flow passage. These seals prevent the entry of fluid from the central cavity or chamber of the body to the downstream flow passage. When the gate is opened, the seals perform no function. For gate valves designed with unidirectional sealing when the gate is closed, fluid will flow past the upstream seat into the chamber or cavity of the body. The fluid pressure in the chamber is sealed by the seal of the downstream seat formed between the gate and the seat. In addition, a sand screen may also be positioned in the seats to protect the valve from sand intrusion.

One drawback in current sealing systems is that the components comprising the means of valve closure do not account for extreme differential thermal effects that may result in physical clamping of the gate, with an attendant increase in friction that can in extreme conditions obviate the primary operation of the valve. Further, sealing and sand intrusion prevention currently requires multiple elements, reducing reliability and requiring additional machining of seats to accommodate those elements. Further, assembly and maintenance is more time consuming due to multiple elements. In addition, because the sand screen is located radially further from the flow path than the sealing element, debris may migrate behind the sealing element and impair the seat-to-body sealing integrity.

A need exists for a technique to enhance sealability and reduce the number of elements for sealing and sand intrusion in a cost-effective manner.

### SUMMARY OF THE INVENTION

In an embodiment of the invention, a gate valve has a body with a cavity and a flow passage intersecting the cavity. A seat ring is mounted to the body at the intersection of the flow passage and the cavity. The seat ring has an engaging face. A gate in the cavity has an engaging face that slidingly engages the face of the seat ring while being moved between open and closed positions.

In this embodiment, a counterbore is formed in the body of the valve and in the flow passage. A seat sealing element is located in a cavity between the seat rings and a counterbore formed in the flow passage and body of the valve. The sealing element may have various shapes, such as a wave shaped metallic shell. The seat sealing element blocks flow from the flow path to the interior of the valve. The sealing element thus advantageously provides sealing between the body of the valve and the seat.

In addition to sealing at the body-to-seat interface, in this example, the sealing element has an axial spring property optimized to exert a force against the body, creating a barrier that advantageously helps prevent debris from migrating behind the seat seal that can degrade sealing integrity. The force exerted by the sealing element also enhances the contact between the face of the seat and the face of the gate. The spring property of the sealing element also accommodates necessary clearances to account for thermal expansion of the seat and gate relative to the constrained body of the valve, thus reducing the possibility of thermal clamping, that may otherwise occur at extreme differentials (e.g. high temperature subsea wells, arctic conditions, etc).

### BRIEF DESCRIPTION OF THE DRAWINGS

FIG. 1 is a vertical sectional view of a gate valve of the prior art.

FIG. 2 is a sectional view of the flow path of the valve of the prior art shown in FIG. 1.

FIG. 3 is an enlarged sectional view of the sealing and sand screen elements of the prior art in the flow path shown in FIG. 2.

FIG. 4 is an enlarged sectional view of the flow path and gate, in accordance with an embodiment of the invention.

FIG. 5 is an enlarged sectional view of the sealing element in FIG. 4, in accordance with an embodiment of the invention.

FIG. 6 is an enlarged sectional view of an embodiment of a sealing element, in accordance with an embodiment of the invention.

FIG. 7 is an enlarged sectional view of an embodiment of a sealing element, in accordance with an embodiment of the invention.

FIG. 8 is an enlarged sectional view of an embodiment of a sealing element, in accordance with an embodiment of the invention.

### DETAILED DESCRIPTION OF THE INVENTION

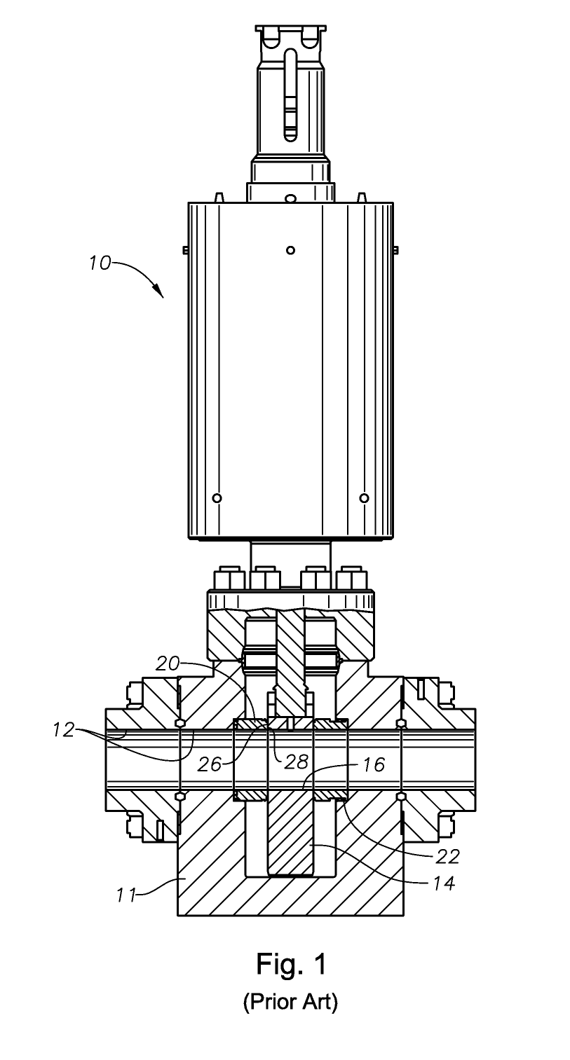

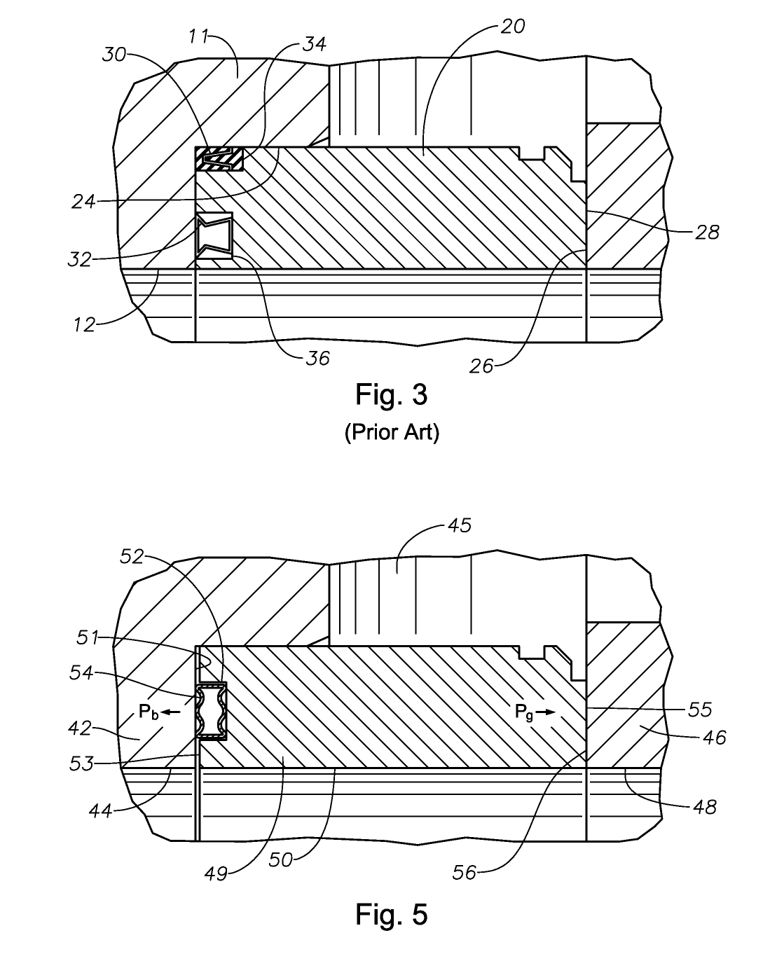

Referring to FIGS. 1 and 3, show a gate valve 10 as known in the prior art. The gate valve 10 has a body 11 and a flow passage 12 that extends transversely through body 11. Valve 10 has a gate 14 with an opening 16 therethrough. Gate 14 is shown in the open position. Also shown in FIG. 1 are ring-shaped valve seats 20 having a lip 22 that seals against a counterbore 24 formed on the body 11. The seats 20 have openings that register with the flow passage 12 of the valve, which intersects a cavity 18 formed in the valve body 11.

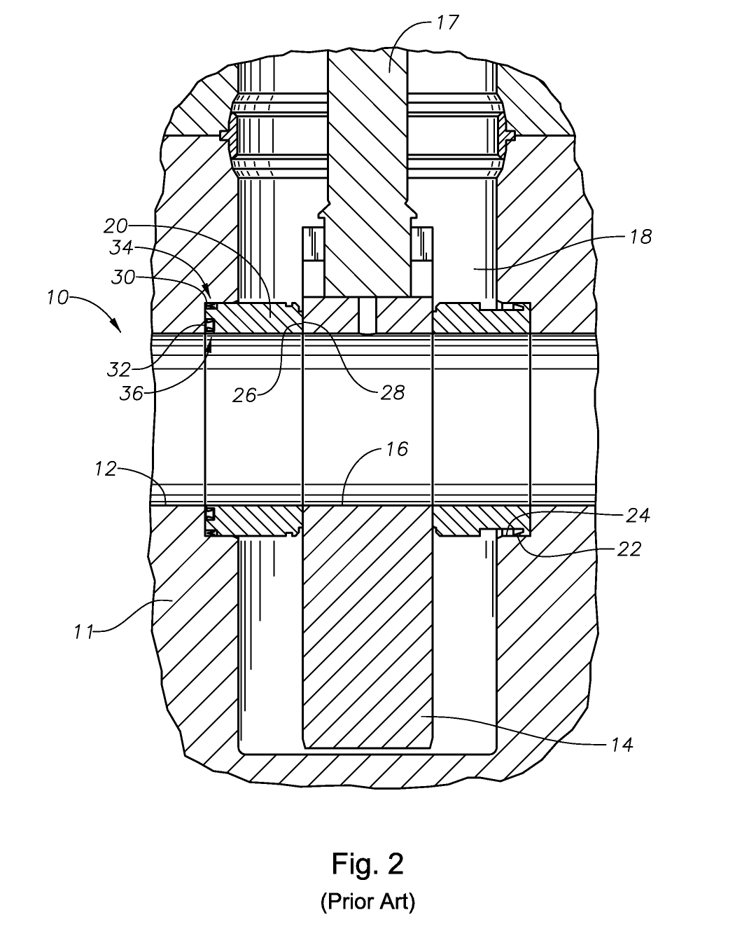

Referring to FIGS. 2-3 of this prior art gate valve 10, when gate 14 is moved to the open position by the stem 17 connected to it, the opening 16 of the gate 14 registers with flow passage 12 of the valve 10, thereby allowing flow through the valve 10. When the gate 14 is closed, the opening 16 no longer registers with the flow passage 12 and thus flow is stopped. The gate 14 has an engaging face 26 on each side that interfaces with a seat face 28. While gate 14 is open, fluid is flowing through the flow path 12. At the interface formed by a seat 20 and the body 11, a sand screen 30 is located to prevent debris from entering the interface. A sealing element 32 is also located at the interface to block the flow of fluid through the interface and into the cavity 18. The screen 30 and sealing element 32 are located within a recesses 34, 36 formed on the seats 20. Although the sand screen 30 and sealing element 32 can provide sealing and debris exclusion at the interface between the seat 20 and body 11, fluid and thus debris may still leak between the gate face 26 and seat face 28 interface into the cavity 18 and into the interface between the seat 20 and body 11, degrading sealability of the valve 10. Further, because clearances between the body 11, seat 20, and gate 14, are minimized to increase sealability, thermal clamping may occur when the valve internals, such as the gate 14 and seat 20 expand due to high temperature or high pressure. Thermal clamping tends to be detrimental to the operation of the valve 10.

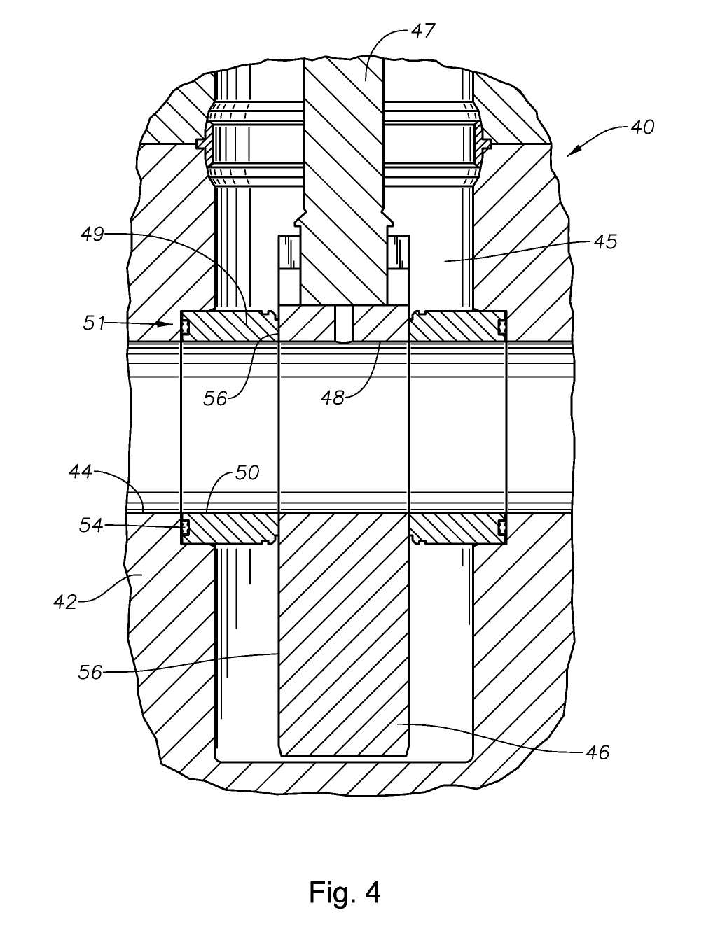

Referring to FIGS. 4 and 5, one embodiment of the invention addressing the issues described above, is shown. As in the prior art, the gate valve 40 in this embodiment has a body 42 and a flow passage 44 that extends transversely through body 42, intersecting a cavity 45. Valve 40 has a gate 46 with an opening 48 therethrough. The gate 46 is moved between open and closed positions by a stem 47 connected to it. In FIG. 4, gate 46 is shown in the open position and is designed as a bi-directional valve that allows fluid to fluid in either direction without sealability degradation. Also shown in FIGS. 4 and 5 are ring-shaped valve seats 49 having an opening 50 that seals against a counterbore 51 formed on the body 42. The openings 50 in the seats 49 register with the flow passage 44 of the valve 40 and the gate opening 48.

In an example embodiment, the gate valve body 42 or gate 46 are made from corrosion resistant steel alloys such as one of the following: Inconel® (a nickel-chrome alloy of steel); high quality low alloy steel; stainless steel; nickel-cobalt alloy steel; or another suitable metal material. Inconel 625 typically has a Rockwell Hardness Number (HRN) in the C scale between 28 and 33. Inconel 718 typically has a Rockwell Hardness Number (HRN) in the C scale between 35 and 40. Material properties can be altered by the heat treatment process. Seats 49 may be formed of the same types of material.

Continuing to refer to FIG. 5, a recess 52 is formed in a face 53 of the seat 49 facing the counterbore 51. A sealing element 54 is carried within the recess 52 and has a spring energy property that mechanically energizes the sealing element 54 when installed. The sealing element 54 may be a metallic shell element with a spring property that can accommodate the necessary clearances to account for thermal effects, such as thermal clamping. In this embodiment, the shape of the sealing element is a shell with a symmetrical wave-like design, with the outer wave profile intermittently coming into contact with the counterbore 51 along a portion of its radial length. An engaging face 55 on the seat ring 49 engages a face 56 on the gate 46. The sealing element 54 may be commercially available from manufacturers such as Nicholsons and may be fabricated from metal, such as Inconel® 718 that can be tuned to obtain a designated axial force. The axial force exerted outward by the sealing element 54 due to the spring property can result in a contact pressure Pg at the gate-to-seat interface of 14 to 150 psi depending on the application. Further, the contact pressure Pb exerted by the sealing element 54 directly on the counterbore 51 may be orders of magnitude larger than Pg due to the smaller contact area between the sealing element 54 and the counterbore 51. Depending on the application, the recess 52 carrying the spring element 54 may vary in depth and length to accommodate the required size of spring element 54.

In this embodiment, when the gate valve 40 is open and fluid is flowing through the flow path 44, the contact pressure Pb against the counterbore 51 due to the energized sealing element 54, establishes a seal at the interface formed by the counterbore 51 and the energized sealing element 54. The seal prevents fluid in the flow path 44 from entering the interface. The contact pressure Pb and barrier created by the sealing element 54 also prevents debris from migrating behind the seat 49 where the debris could degrade sealability. Further, the contact pressure Pg due to the spring element 54, between the face 55 of the seat and the engaging face 56 of the gate 46, enhances the seal and also prevents debris migration. The sealing element 54 may also prevent thermal clamping associated with the expansion of valve internals such as the gate 46 and seat 49. This is achieved by allowing the spring element 54 to bridge the clearances and expand and contract as the internals also expand or contract. The clearances may then be lessened such that thermal clamping is reduced or prevented.

The sealing element 54 and seat ring 49 may be installed within the valve 40 in various ways. A tool can be used to push the seat rings 49 and sealing elements into place against the counterbores 51. Ice or similar block of material may be used to then temporarily hold the seat rings 49 in place prior to the insertion of the gate 46. Once the block of material is displaced into, for example, the cavity 45, the block is dissolved or melted by solvent or temperature.

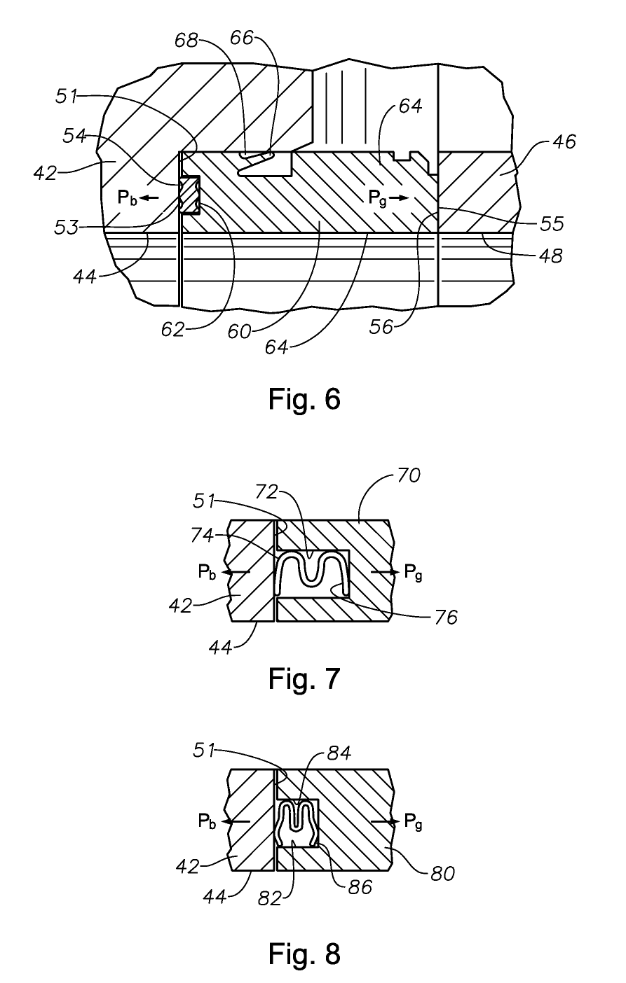

In another embodiment, illustrated in FIG. 6, the same sealing element 54 as that shown in FIG. 5 is carried within a recess 62 formed in a seat ring 60 having an opening 64 that registers with the flow path 44. However, the seat ring 60 in this embodiment also has a lip 66 formed on an outer surface that is in contact with the body 42 of the valve 40 (FIG. 4) The lip 66 is inclined radially outward from a base and defines a pocket 68 between the lip 66 and the body 42. The lip 66 and pocket 68 provide a backup sealing arrangement to the sealing element 54 if needed. In addition, a flex lip 64 may be formed on the seat ring 60 to further accommodate thermal expansion and further enhance a metal-to-metal seal between the seat 60 and the gate 46.

In another embodiment, illustrated in FIG. 7, a seat ring 70 has a recess 72 formed on the side of the seat ring 70 facing the counterbore 51. A sealing element 74 carried within the recess 72 has an M-shape cross-section with legs 76 that spring axially outward into contact with the counterbore 51 and the recess 72. The legs 76 of the sealing element 74 have a spring effect like that of FIG. 5 that generates the axial contact forces Pb and Pg to enhance sealability, exclude debris, and accommodate thermal expansion.

In another embodiment, illustrated in FIG. 8, a seat ring 80 has a recess 84 formed on the counterbore 51 side of the seat ring 80. The sealing element 84 carried within the recess 82 also has an M-shape with legs 86 that come into contact with the counterbore 51 and the recess 82. The legs 86 of the sealing element 84, like those in FIG. 7, also have a spring effect like that of FIG. 5 that generates the axial contact forces Pb and Pg to enhance sealability, exclude debris, and accommodate thermal expansion. In this embodiment, the legs 86 bulge outward adjacent their free ends.

The sealing elements described above combine a spring effect to generate contact forces against the counterbore and the gate-seat interface, thus creating a barrier that seals off flow from the flow path of the gate valve. Further, the same sealing element effectively prevents debris exclusion and accommodates expansion of the valve internals due to high temperature or high pressure conditions. Thus, sealability, debris exclusion, and thermal clamping prevention, are accomplished with a single element rather than multiple elements of lesser performance. The invention thus results in a more effective and reliable seal.

This written description uses examples to disclose the invention, including the best mode, and also to enable any person skilled in the art to practice the invention, including making and using any devices or systems and performing any incorporated methods. These embodiments are not intended to limit the scope of the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A gate valve, comprising:
a body having a chamber;
a flow passage having an axis and extending transversely through and intersecting the chamber;
a counterbore formed in the flow passage at each intersection with the chamber;
seat rings in each counterbore;
a gate that is actuated between open and closed positions through the chamber to allow control of the flow of fluid through the flow passage; and
an annular sealing element located between each counterbore and each seat ring for sealing between an interface of the counterbore and the seat ring that prevents fluid and debris from flowing past the seal behind the interface.

2. The apparatus according to claim 1, wherein the sealing element exerts a distributed force through the seat ring against the gate to create a seal between an interface of the gate and the seat ring that prevents fluid and debris from flowing into the interface.

3. The apparatus according to claim 1, wherein each of the seat rings has an annular recess for receiving the sealing element.

4. The apparatus according to claim 1, wherein the distributed force exerted by the sealing element through the seat ring against the gate ranges from 14 to 150 psi.

5. The apparatus according to claim 1, wherein the annular sealing element expands in response to expansion of the gate or seat ring when subjected to high temperature or high pressure.

6. The apparatus according to claim 1, further comprising a lip formed on the seat ring that is in contact with the body, the lip projecting radially outward from a base and defining a pocket formed between the lip and the body.

7. The apparatus according to claim 1, wherein the annular sealing element is a metallic shell having a cross-section with an undulating shape.

8. The apparatus according to claim 1, wherein the annular sealing element is a metallic shell having an M-shape with a pair of legs, one of which contacts the counterbore and the other the seat ring.

9. A method of sealing, comprising:
providing a body having a chamber;
forming a flow passage having an axis and extending transversely through and intersecting the chamber;
forming a counterbore in the flow passage at each intersection with the chamber;
locating seat rings in each counterbore;
actuating a gate between open and closed positions through the chamber to allow control of the flow of fluid through the flow passage; and
disposing an annular sealing element between each counterbore and each seat ring for sealing between an interface of the counterbore and the seat ring that prevents fluid and debris from flowing past the seal behind the interface.

10. The method of claim 9, further comprising the step of:
selecting the sealing element that exerts a desired distributed force against the counterbore to create a seal between an interface of the counterbore and the seat ring that prevents fluid and debris from flowing past the seal behind the interface.

11. The method of claim 9, further comprising the step of:
selecting the sealing element that exerts a desired distributed force through the seat ring against the gate to create a seal between an interface of a gate of the valve and the seat ring that prevents fluid and debris from flowing into the interface.

12. The method of claim 9, further comprising the step of selecting the sealing element that bridges a clearance between the counterbore and the seat ring and contracts to account for thermal expansion of the gate and seats in the valve or the seat ring to thereby avoid the potential of thermal clamping.

13. A method of sealing and excluding debris in a gate valve, comprising:
forming a counterbore in a flow passage at each intersection with a chamber of the gate valve;
locating a cylindrical seat ring within the counterbore;
forming an annular recess on counterbore-facing face of the seat ring;
sealing interfaces between the counterbore and seat ring, and counterbore and a gate by disposing an annular sealing element between the counterbore and the seat ring that has a spring property.

14. The method of claim 13, further comprising the step of:
selecting the sealing element that exerts a desired distributed force against the counterbore to create a seal between an interface of the counterbore and the seat ring that prevents fluid and debris from flowing past the seal behind the interface.

15. The method of claim 13, further comprising the step of:
selecting the sealing element that exerts a desired distributed force through the seat ring against the gate to create a seal between an interface of a gate of the valve and the seat ring that prevents fluid and debris from flowing into the interface.

16. The method of claim 13, further comprising the step of selecting the sealing element that bridges a clearance between the counterbore and the seat ring and contracts to account for thermal expansion of the gate and seats in the valve or the seat ring to thereby avoid the potential of thermal clamping.
